(19) United States
(12) Patent Application Publication
(10) Pub. No.: US 2009/0283022 A1
(43) Pub. Date: Nov. 19, 2009

(54) METHOD AND APPARATUS FOR CROP PLANTING

(76) Inventor: Dennis Johnson, Salinas, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 12/122,058

(22) Filed: May 16, 2008

(51) Int. Cl. A01C 7/00

(52) U.S. Cl. 111/200

(57) ABSTRACT

A system and method for planting row crops in a field. A field is planted utilizing a three-bed planter, such that the area planted during a pass of the planter is directly adjacent to the area planted during an adjacent pass of the planter, with no furrow existing between them. The result is a field having beds that are twice or more than twice the width of standard beds, alternating with standard width beds. Yield of crop is increased due to more efficient use of available field space, and improved efficiency of mechanical harvesting.

### TECHNICAL FIELD

The present invention relates to the planting of row crops. More particularly, the present invention relates to an improved system and method for planting row crops that increases the yield per acre of crop.

### BACKGROUND ART

As human populations continue to grow, so does the demand for food. Moreover, rising standards of living in developing nations and regions result in added pressure on agricultural production systems. Thus, improvements in efficiency are sought to increase the production and yield of agricultural products. The present invention is drawn to an improved method of planting row crops that increases the yield per acre of crop.

According to standard methods for planting row crops, farmers create parallel 40-inch or 80-inch beds separated by furrows, typically having two or five rows of plants, respectively. (See FIG. 1.) Tractors and planters are designed to accommodate such dimensions, having wheelbases and/or sled-tracks of the appropriate width. During the planting process, the tractor and planter wheels/sled-tracks are driven in the furrows.

However, problems exist in the use of standard 80-inch beds. Specifically, the creation of furrows tends to cause the plants located immediately adjacent to them to grow at an angle, leaning in the direction of the furrow. While this lean can be accommodated when harvesting by hand, it causes problems when harvesting is performed by mechanical harvesters. Examples of mechanical harvesters include the Sutton Ag Ortomec harvesters and the Ramsay Highlander Mechanical Harvesters. Because mechanical harvesters operate by cutting at the base of plants in a horizontal manner, they are unable to properly harvest crops growing at an angle. The result is that these crops are compromised due to their being harvested in a less-than-ideal fashion, which results in a loss of yield. In the case of a five-row bed, the two outside rows—potentially up to 40% of the crops—may be compromised when harvested mechanically.

Moreover, each furrow represents land that could otherwise be utilized for planting additional crops. In the case of a field of 80-inch beds, approximately 10 to 20% of the available field space is not planted because it is used for furrows.

Therefore, there is a need for an improved system and method of planting row crops. Such an improved system and method would yield greater amounts of crop per acre by utilizing available land more efficiently, and by diminishing loss due to crop that is compromised during mechanical harvesting.

### DISCLOSURE OF INVENTION

The present invention is drawn to an improved system and method for planting row crops that addresses the aforementioned problems in the prior art.

The present invention maximizes yield of row crops by maximizing the use of available land for planting, and by minimizing the number of furrows.

Moreover, the present invention increases yield per acre by minimizing the number of plants subject to compromise during mechanical harvesting due to growth at an angle.

In accordance with the system and method of the present invention, a field is planted by operating a conventional three-bed planter in parallel passes in a novel manner so as to plant one bed and two half-beds during each pass. The area planted during a pass of the planter is contiguous with the area planted during a successive adjacent pass of the planter, with no furrow existing between them. The result is a field having alternating beds of different widths—approximately half being of standard width and approximately half being twice the width of standard beds.

In an alternative embodiment of the present invention, a three-bed planter is modified so as to have a center section of standard width, and two flanking sections each having a width greater than the center section and each being capable of planting a greater number of rows than the center section. A field is planted utilizing the modified three-bed planter, such that the area planted during a pass of the planter is contiguous with the area planted during a successive adjacent pass of the planter, with no furrow existing between them. The result is a field having alternating beds of different widths—approximately half being of standard width and approximately half being more than twice the width of standard beds.

### BRIEF DESCRIPTION OF THE DRAWINGS

FIG. 1 illustrates, in cross-section views, conventional 40-inch and 80-inch beds.

FIG. 2 illustrates, in a cross-section view, a portion of a field planted according to standard methods of planting utilizing a three-bed planter.

FIG. 3 illustrates, in a cross-section view, a portion of a field planted according to an improved system and method of planting utilizing a three-bed planter, in accordance with an embodiment of the present invention.

FIG. 4 illustrates a three-bed planter in accordance with an embodiment of the present invention.

FIG. 5 illustrates, in a cross-section view, a portion of a field planted according to an improved system and method of planting utilizing a three-bed planter, in accordance with an alternative embodiment of the present invention.

### BEST MODES FOR CARRYING OUT THE INVENTION

The present invention is drawn to an improved system and method for planting row crops that maximizes yield by minimizing the number of furrows and minimizing the number of plants compromised by mechanical harvesting.

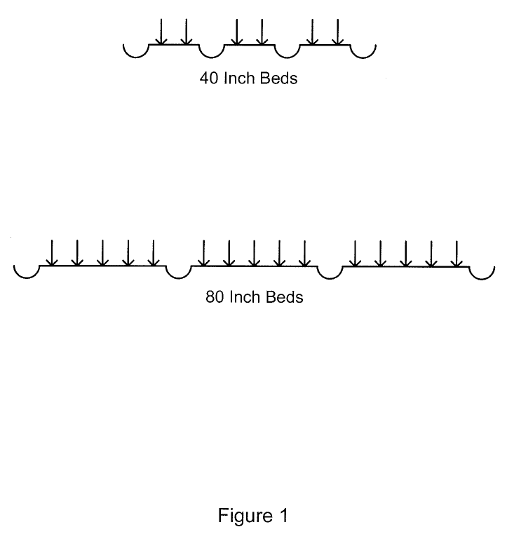

As shown in FIG. 1 and discussed above, row crops are conventionally planted in parallel 40-inch or 80-inch beds, having two or more rows, that are separated by furrows. Modern multi-bed planters are typically operated in parallel passes so as to plant multiple crop beds simultaneously during each pass.

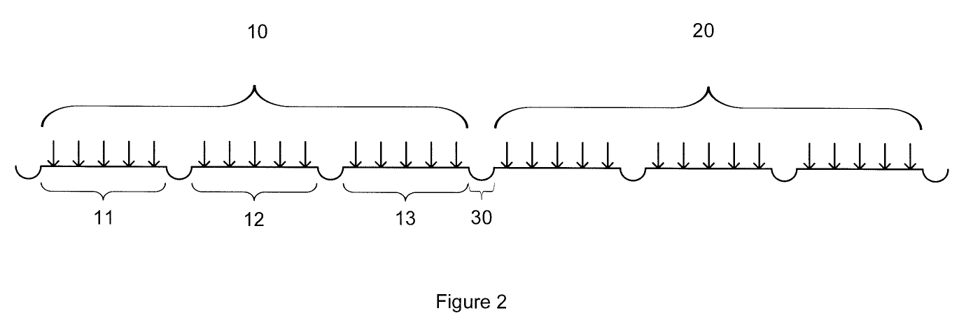

FIG. 2 illustrates, in a cross-section view, a portion of a field planted according to standard methods of planting utilizing a three-bed planter. According to the standard methodology, fields are sectioned and planted having parallel beds of equivalent width, separated by furrows. This is accomplished by operating a planter in parallel passes across the field. As is known in the art, the three-bed planter is designed to plant three equivalent beds simultaneously, with gaps in the planter's array allowing for the two furrows that lie in between the beds. A typical three-bed planter has a center section and two equivalent flanking sections. In operation, the three-bed planter is towed by a tractor whose wheels are driven in the furrows. Three-bed planters are available from manufacturers such as Sutton Ag Enterprises. In order to create equivalent beds when planting with a three-bed planter, a furrow is positioned between the areas planted during adjacent passes of the three-bed planter. As shown in FIG. 2, during a first pass, the area 10 is planted, which includes three beds (11, 12, 13). Each bed is shown having five rows of plants, but the number of rows may vary as necessary depending on the desired spacing of plants. During a successive adjacent pass, the area 20 is planted, with furrow 30 separating area 20 from area 10. Additional areas are planted in a likewise manner, with a furrow separating each area planted from adjacent planted areas. The final result is a field consisting of equivalent beds wherein each bed is separated from adjacent beds by furrows. Modern techniques employing GPS technology facilitate the application of such planting techniques with a high degree of precision.

Furrows provide access to plants for care and maintenance activities such as thinning, and are also necessary for ground or drip irrigation. However, not all plants require such activity, and may be grown using overhead or sprinkler irrigation methods. Because each furrow that is created represents land that is not used for planting, it is desirable to minimize the number of furrows in a field, and so increase the yield of crop.

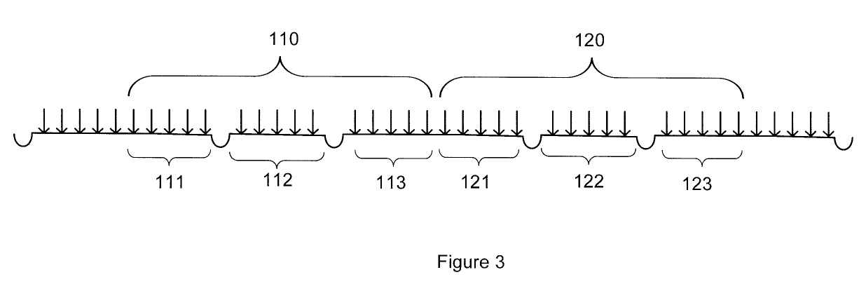

FIG. 3 illustrates, in a cross-section view, a portion of a field planted according to an improved system and method of planting utilizing a three-bed planter, in accordance with an embodiment of the present invention. According to the improved method herein described the number of furrows created during planting is minimized, thus producing a field of alternating wide and standard width beds. In the present embodiment as shown in FIG. 3, a three-bed planter is utilized which plants three sections having five rows of plants each. Under conventional use, these three sections would correspond to three beds planted having five rows each. However, according to the improved system and method of the present invention as shown in FIG. 3, the “three-bed” planter is utilized in a novel manner to plant one bed and two half-beds during each pass. Thus, during a first pass, the area 110 is planted, which includes half-bed 111, bed 112, and half-bed 113. During an adjacent pass, the area 120 is planted, which includes half-bed 121, bed 122, and half-bed 123. The area 120 is planted so as to be contiguous with area 110, such that no furrow exists between them. This creates a single wide bed composed of half-beds 113 and 121, having ten rows of plants. Additional areas are planted in a likewise manner, with no furrow separating a given area planted during a pass of the planter from an area planted during an adjacent pass of the planter. The final result is a field consisting of alternating beds having five or ten rows, separated by furrows.

The embodiment of the present invention has been described with reference to a planter capable of planting three equivalent sections of five rows each. It is recognized that the number of rows may vary in accordance with the desired spacing of plants. Moreover, it is further recognized that the presently described system and method may be improved by increasing the width of the sections of the planter in order to facilitate the planting of additional rows.

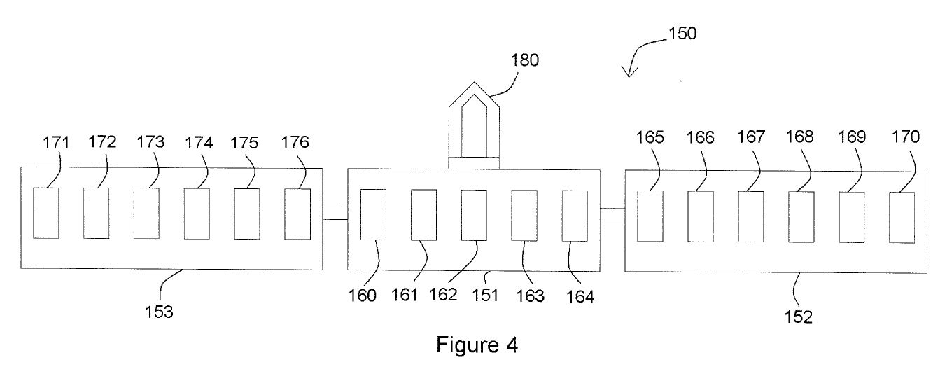

FIG. 4 illustrates a modified planter 150 capable of planting three beds or, in accordance with the method of the present invention, one bed and two half-beds, during a single pass. The planter 150 has a center section 151, and two flanking sections 152 and 153. The flanking sections 152 and 153 are modified so as to each be of greater width, and consequently capable of planting a greater number of rows, than section 151. As shown, center section 151 has five planter units 160 to 164, while flanking sections 152 and 153 each have six planter units 165-170 and 171-176, respectively. Connector 180 allows the planter 150 to be attached to a tractor for towing. While planter 150 is shown having five or six planter units in each section, the number of planter units may vary depending on the particular crop being planted, desired density of plants, and other factors. It is also possible to plant different crops simultaneously with the same planter.

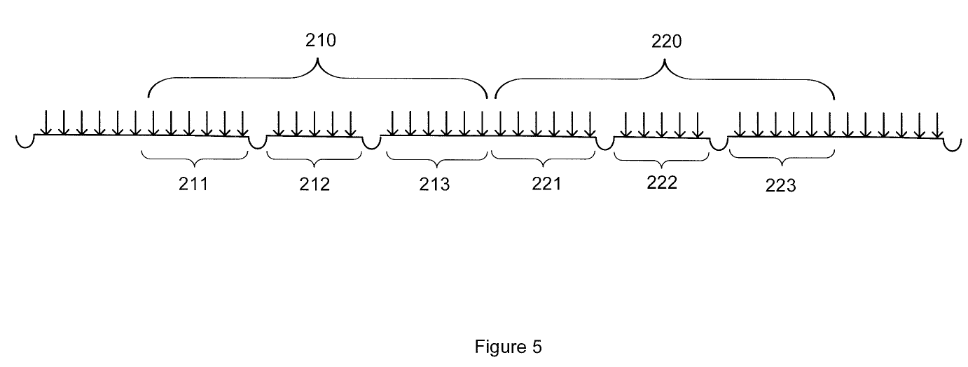

FIG. 5 illustrates, in a cross-section view, a portion of a field planted according to an improved system and method of planting utilizing the planter 150 as described above, in accordance with an alternative embodiment of the present invention. As shown in FIG. 4, the three-bed planter is modified so as to have two flanking six-row sections, and a center five-row section. Under conventional use, these three sections would correspond to three beds planted having five or six rows each. However, according to the improved system and method of the present invention as shown in FIG. 5, the modified “three-bed” planter is utilized to plant one bed and two half-beds during each pass. Thus, during a first pass, the area 210 is planted, which includes half-bed 211, bed 212, and half-bed 213. During an adjacent pass, the area 220 is planted, which includes half-bed 221, bed 222, and half-bed 223. The area 220 is planted so as to be contiguous with the area 210, such that no furrow exists between them. This creates a single wide bed composed of half-beds 213 and 221, having twelve rows of plants. Additional areas are planted in a likewise manner, with no furrow separating a given area planted during a pass of the planter from an adjacent area planted during an adjacent pass of the planter. The final result is a field consisting of alternating beds having five or twelve rows, separated by furrows.

As stated previously and well known in the art, a field is planted by operating a planter in parallel passes. However, it is recognized that the particular order in which the parallel passes are performed may vary. Adjacent areas planted during two different passes need not be planted in immediate succession, but may be planted according to any ordering known in the art. The end result is such that the area planted by one of the flanking sections of the three-bed planter during a given pass is contiguous with the area planted by one of the flanking sections during an adjacent pass of the planter. Modern methods of preparing and sectioning a field for planting, including methods utilizing GPS technology, allow farmers to operate planters over both adjacent and non-adjacent areas with a high degree of precision. Therefore, for purposes of the present invention, the particular order according to which parallel passes are performed is not of consequence, as any order may suffice, this being contemplated within the scope of the present invention.

As demonstrated, the system and method of the present invention is useful for planting row crops in such a manner as to reduce the number of furrows and create extremely wide beds that are more than twice the width of conventional beds. In addition to the increase in yield owing to the productive use of land that would otherwise have constituted barren furrows, yield when harvesting by automated mechanical harvesters is improved as well. Plants growing adjacent to a furrow tend to grow at an angle leaning towards the furrow, due to settlement of the soil and other factors. However, mechanical harvesters operate by cutting in a horizontal fashion that does not account for plants growing at an angle. Thus, plants growing adjacent to a furrow tend to be compromised when harvested mechanically, as they may be cut on a bias that cuts through desirable portions of the plant. With the reduction in the number of furrows that is produced according to the system and method of the present invention, there is a concomitant reduction in the number of plants that must grow adjacent to furrows. Thus, fewer plants are compromised when harvested mechanically, thereby increasing the overall yield.

Information as herein shown and described in detail is fully capable of attaining the above-described object of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, in which reference to an element in the singular is not intended to mean “one and only one” unless explicitly so stated, but rather “one or more.”

All structural and functional equivalents to and combinations of the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. §112, sixth paragraph, unless the element is expressly recited using the phrase “means for.”

### INDUSTRIAL APPLICABILITY

The present invention is industrially applicable to methods of planting row crops, and to planters for planting row crops.

What is claimed:

1. A method for planting a field of row crops, said method comprising the following steps:
Sectioning said field for planting with a three-bed planter in parallel passes, said three-bed planter having a center section and two flanking sections, wherein the area to be planted by one of said flanking sections during a given pass of the three-bed planter is contiguous with the area to be planted by one of said flanking sections during an adjacent pass, such that the adjacent areas have no furrow between them;
Planting said field by operating said three-bed planter in accordance with said sectioning.

2. A field planted with row crops having a configuration of alternating parallel beds of a standard width and a width at least twice said standard width, said field being planted by operating a three-bed planter in a series of parallel passes so as to form parallel beds, said three-bed planter having a center section and two flanking sections, wherein the area planted by one of said flanking sections during a given pass of the three-bed planter is contiguous with the area planted by one of said flanking sections during an adjacent pass, such that the adjacent areas have no furrow in between them.

3. A planter for planting row crops, said planter having a center section and two flanking sections for planting multiple rows, wherein each of said two flanking sections has a width greater than said center section, and wherein each of said two flanking sections is capable of simultaneously planting a greater number of rows than said center section.
